(19) United States
(12) Patent Application Publication
(10) Pub. No.: US 2004/0104336 A1
(43) Pub. Date: Jun. 3, 2004

(54) Fiber optic sensing system

(76) Inventors: Ivan Melnyk, Coquitlam (CA); David Yue Yan, Richmond (CA); Ondrej Mecl, New Westminster (CA); Derek Montgomery, New Westminster (CA)

Correspondence Address: Chernoff, Vilhauer, McClung & Stenzel, L.L.P., 1600 ODS Tower, 601 S.W. Second Avenue, Portland, OR, 97204-3157, US

(21) Appl. No.: 10/712,449

(22) Filed: Nov. 12, 2003

(30) Foreign Application Priority Data
Nov. 12, 2002 (CA) 2,411,638

(51) Int. Cl. G01J 1/04; G01J 5/08

(52) U.S. Cl. 250/227.14

(57) ABSTRACT

The invention provides a fiber optic sensing system for use in environments hostile to electronics. The system comprises an optical module comprising a light source and a photodetector, a probe comprising a glass optical fiber core, preferably with a transducer sensitive to the measurement parameter coupled thereto, an extension comprising a plastic optical fiber core, a first connector configured to optically couple the extension to the probe and a second connector configured to optically couple the extension to the optical module. Light emitted from the light source is transmitted to the transducer on the probe and returned to the photodetector by the extension.

### TECHNICAL FIELD

The invention relates to optical sensing of various physical parameters such as temperature and pressure, and more particularly, to fiber optic sensing in harsh industrial environments.

### BACKGROUND

Fiber optic cables may be used to connect sensing probes located in hostile environments with electronics that are not suitable for certain hazards. Such environments include explosive atmospheres that may be ignited by electrical sparks, locations subjected to significant levels of electromagnetic interference, caustic or corrosive media, or locations submersed in fluids. Low intensity light cannot ignite explosions and is immune to electromagnetic interference, and optical fiber technology is widely used in wet or corrosive atmospheres. The electronics, including a light source and a photodetector, can be located at a considerable distance away from the measurement environment, isolated from the environmental hazards.

It is known to use glass fiber optic cables for a variety of fiber optic sensing applications. (See, for example, “Fiber Optic Sensors”, Eds. F. T. S. Yu and S. Yin: Marcel Deccer, 2002, Optical Fiber Sensor Technology: Applications and Systems” Eds. K. T. V. Grattan and B. T. Meggitt, Kluwer Academic Publishers, 1999).

Fiber optic sensors may be referred to as being either “high coherence” or “low coherence”. High coherence fiber optic sensors rely on properties of light such as phase, and as such require a coherent light source and small core “single mode” fiber optic cables which preserve the coherence of the light. Low coherence fiber optic sensors rely primarily on the intensity of the light to measure physical parameters, and as such may use an-incoherent light source and larger core cables.

Light sources used with low coherence fiber optic sensors for industrial applications are preferably robust and inexpensive, such as light emitting diodes (LEDs) or miniature incandescent lamps. The amount of light that can be coupled from such a light source into a sensing probe is proportional to the cross-sectional area of the fiber optic cable. Accordingly, fiber optic cables having the largest possible core diameter are preferable for use with incoherent fiber optic sensors.

Large diameter glass fibers suffer from several practical problems that limit their use in harsh industrial environments, such as petroleum processing plants, electrical power stations, and marine applications. The larger the diameter, the more susceptible the fibers are to breakage. The minimum bend radius is an important consideration when routing cables in buildings or industrial plants. For glass fibers, a minimum bend radius of approximately 300 times the diameter has been established. This translates to a practical maximum limit of approximately 500 microns on the diameter of glass fibers, since beyond this the glass fibers will not be able to bend sufficiently for most applications.

There exist polymer optical fibers, such as polymethyl methacrylate (also known as “PMMA”) fibers, which are more bendable than glass fibers. However, these plastic fibers are not as resistant to corrosive chemicals and elevated temperatures as are glass fibers. Furthermore, the transmittance of plastic optical fibers is generally inferior to glass, especially in the near infra-red spectrum which is most commonly used for telecommunications. Accordingly, visible wavelengths must be utilized to maximize the transmission distance, as required for applications where the sensor must be located at a significant distance from the processing electronics.

Periodic replacement of the sensing probe may be required in hostile conditions such described in U.S. Pat. No. 4,883,354. For this reason, the fiber optic system of the sensor is often made of two parts which includes a short sensing probe (typically from 5 to 50 cm) and an extension. The distance between the sensing probe and processing electronics can vary from a fraction of meter to tens of meters, so the extensions are often cut or “terminated” in the field. Glass fibers must be terminated using specialized equipment that is difficult and cumbersome to deploy in field situations. This is particularly the case for large core fibers, where cleaving techniques are not reliable, and the fiber tips must be polished to achieve acceptable coupling efficiencies. In addition, shape imperfections on the polished ends of large core glass fibers can create an optical edges between the sensing probes and the fiber optic cables which may disturb the interference picture in fiber optic interferometric sensors.

Another significant drawback associated with the use of glass fiber optic cables is the cost involved. The cost of glass fibers typically increases as a square of the diameter. Consequently, large core glass fibers can be very expensive.

There exists a need for industrial fiber optic sensing devices with inexpensive and rugged extension cables that will provide an effective connection between the sensing probe and the processing electronics.

### SUMMARY OF INVENTION

The invention provides a fiber optic sensing system comprising an optical module comprising a light source and a photodetector, a probe comprising a glass optical fiber core, an extension comprising a plastic optical fiber core, a first connector configured to optically couple the extension to the probe and a second connector configured to optically couple the extension to the optical module. Light emitted from the light source is transmitted to the probe and returned to the photodetector by the extension. The light source may be incohoerent.

The plastic optical fiber core may have a diameter greater than 0.25 millimetres, and may be constructed from polymethyl methacrylate. The glass optical fiber core may have a diameter greater than 0.25 millimetres. The glass optical fiber core generally has the same diameter as the plastic fiber. An oversized extension fiber may be utilized which results in equivalent system efficiency but is more tolerant of radial alignment errors of the butt coupled fiber connection.

A transducer may be coupled to the probe. The light source may emit blue light and the transducer may comprise a temperature sensitive phosphor configured to emit red light when excited by blue light. Alternatively, the transducer may comprise a cavity with a pressure sensitive membrane, or a coating configured to react to specific chemical substances.

### BRIEF DESCRIPTION OF DRAWINGS

In drawings which illustrate non-limiting embodiments of the invention:

FIG. 1 schematically depicts a fiber optic sensing system according to a preferred embodiment of the invention;

FIG. 2A shows a sensing probe and a “thermowell” in thermal contact with a measurement environment;

FIG. 2B shows a sensing probe in direct contact with a measurement surface;

FIG. 2C shows a sensing probe some distance away from a measurement surface;

FIG. 3A shows a typical prior art coaxial connector;

FIG. 3B shows a connector with two offset misaligned fibers, including a magnified view of the misalignment;

FIG. 3C shows a connector with two angularly misaligned fibers, including a magnified view of the misalignment;

FIG. 4 shows a beam splitter for use with a fiber optic sensing system with a single fiber optic cable, according to a preferred embodiment of the invention;

FIG. 5 shows a sensing probe comprising separate illuminating and receiving fibers according to another embodiment of the invention;

FIG. 6A shows a fiber optic junction with an angular error;

FIG. 6B shows a plastic fiber optic cable according to the invention wherein the fiber protrudes from the cladding; and,

FIG. 6C shows a plastic fiber compressed against a glass fiber according to a preferred embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

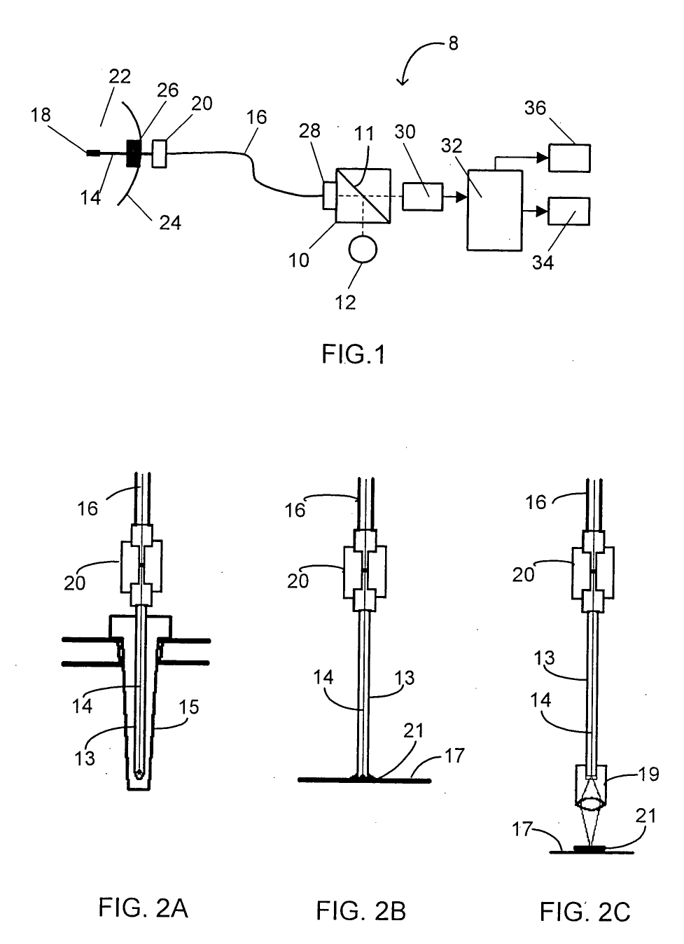

FIG. 1 schematically depicts a fiber optic sensing system 8 according to a preferred embodiment of the invention. System 8 comprises an optical module 10 that provides illumination from a light source 12 to a fiber optic sensing probe 14 through a plastic extension 16. Probe 14 preferably has a transducer 18 coupled to its distal end and a connector 20 coupled to its proximal end.

Transducer 18 may comprise, for temperature sensing applications, a fluorescent material such as a phosphor which fluoresces when excited by light from light source 12. In such an embodiment, light source 12 is selected to generate the wavelength spectrum necessary to excite the fluorescent material. There are many available fluorescent material types, but ones that generate fluorescent wavelength spectra in the visible or near infrared wavelengths are preferred because they match the sensitivity spectrum of commonly available silicon photodetectors, and PMMA fibers are particularly transparent in the visible wavelength spectrum. The wavelength of the excitation light is preferably shorter than the fluorescent wavelength spectrum, so green, blue, and ultraviolet wavelengths are generally preferred. Light source 12 may comprise an incandescent or discharge lamp, but these devices are not practical for many applications because of lifetime and reliability limitations. Light source 12 preferably comprises an LED for most industrial applications because of the robust characteristics and very long life of LEDs. Recently available GaN LED's produce deep blue light of sufficient brightness suitable for exciting fluorescent materials. For fiber optic pressure sensing using white light interferometry, white LED's are preferred; they generate a wide spectrum of light ranging from 400 nm to 700 nm thus reducing the coherence length to a few microns only. A combination of LED's may be used for excitation of phosphor at different wavelengths or for spectral expansion of the light source.

The configuration of probe 14 will depend on the desired application. For measuring the temperature inside chemical processing vessels or pipelines, a “thermowell” 15 is commonly used to penetrate the vessel and secure probe 14 in thermal contact with the measurement environment, as shown in FIG. 2A. For surface temperature measurements, the tip of probe 14 can be brought in direct contact with a surface 17, as shown in FIG. 2B, or a fluorescent material 21 can be applied directly to the measurement surface 17 and probe 14 can be located some distance away, as shown in FIG. 2C. The distance between probe 14 and the measurement surface 17 can be considerable if focusing optics 19 are used.

Preferably, probe 14 is enclosed by a rigid housing 13 (not shown in FIG. 1) located inside of a measurement environment 22. The housing 13 enclosing probe 14 can be made in any number of different shapes, sizes, materials, and mounting arrangements, to suit specific measurement requirements. The choice of fiber used for probe 14 and the construction of probe 14 are also dependent on the application, and in particular the maximum temperature that probe 14 must withstand. The following table shows the maximum temperature, available core diameters and minimum bend radii for some currently available types of fiber:

| | Maximum | | |
|---|---|---|---|
| | Operating | Core diameters | Minimum |
| Fiber Type | Temperature | available | Bending Radius |
| All plastic | 100 degrees C. | 0.25-2 mm | 10 diameters |
| (PMMA) | | | |
| Plastic Coated | 300 degrees C. | 0.10-1 mm | 300 diameters |
| Silica | | | |
| All silica | 600 degrees C. | 0.05-1 mm | 600 diameters |
| Sapphire fibers | 1000 degrees C. | 0.5-2 mm | >1000 diameters |
| and rods | | | |

Measurement environment 22 may be hazardous, and is preferably separated from the ambient environment by a wall 24. Probe 14 is preferably fixed in wall 24 by means of a fitting 26. Preferably, fitting 26 comprises a thermowell, as shown in FIG. 2A, a high pressure industrial fitting, or the like.

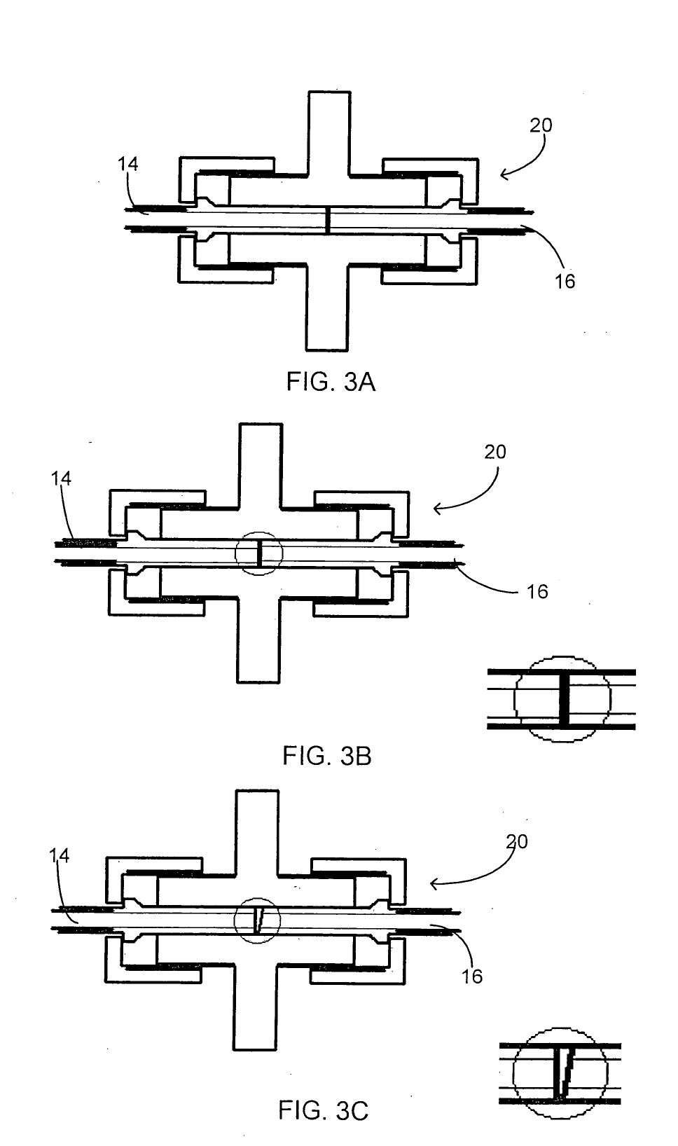

Extension 16 is coupled to optical module 10 by means of another connector 28, which is preferably identical to connector 20. There are a number of available commercial fiber-optic connector types, and FIG. 3A shows a typical butt coupled coaxial connector with a threaded locking collar mated to a bulkhead receptacle. The diameter of plastic extension 16 is preferably equal to the diameter of the fiber used for probe 14. A small radial misalignment, as shown in FIG. 3B, will cause a minor effect on light coupling for large core fibers. Accordingly the diameter of plastic extension 16 may alternatively be slightly larger than the diameter of probe 14, so that some radial misalignment can be tolerated without losing signal amplitude. The numerical aperture of plastic optical fibers is also very high (typically greater than 0.5), which makes the butt connections insensitive to angular misalignments, as shown in FIG. 3C.

Optical module 10 collects and optically transforms light coming back from probe 14 through extension 16. The optical transformation may include spectral filtering using narrow-band or wide-band optical filters or temporal filtering using interferometers. After transformation, optical module 10 concentrates the light into a photodetector 30, which preferably comprises a discrete photodiode or a linear array photodetector such as a CCD or CMOS. Signals from photodetector 30 are processed in a signal processing unit 32. Many types of signal processing are possible. A detailed discussion of the signal processing is not included in this description to avoid obscuring the invention. The results of signal processing may be displayed by an indicator 34, or they may sent to an external control system by a communication module 36, or both.

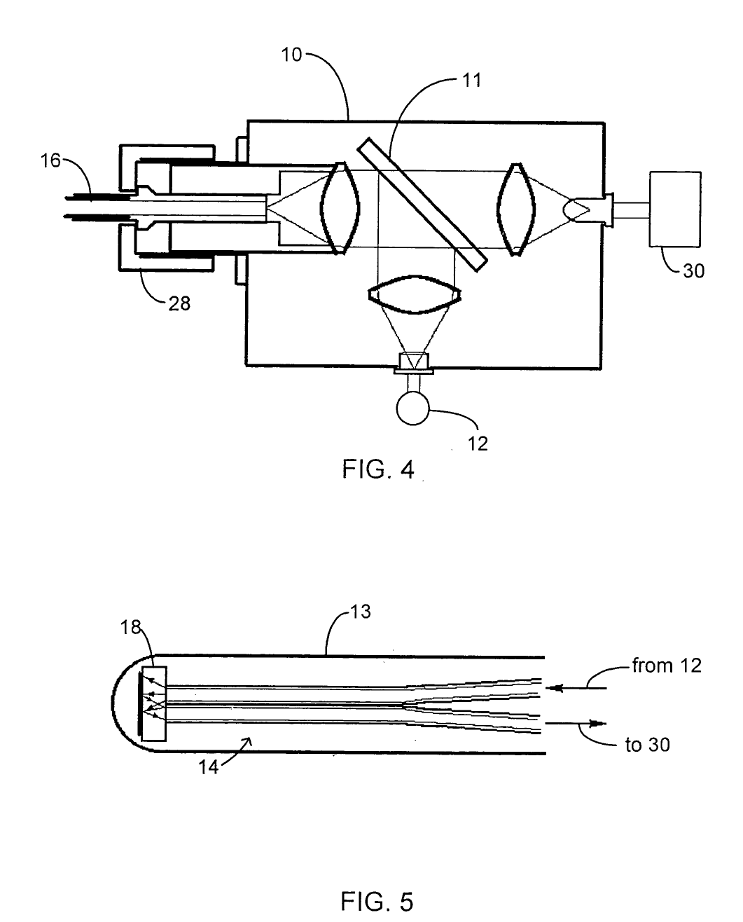

Extension 16 preferably comprises a single fiber, and in such embodiments, optical module 10 includes a beam splitter 11. FIG. 4 shows a beam-splitter 11, positioned between light source 12 and the entrance face of extension 16, to redirect a portion of the returning light on to photodetector 30. The beam splitter can be made with dichroic coatings, which reflect a high proportion of the fluorescent light while transmitting a high proportion of the excitation light, to improve the optical efficiency of system 8. In another embodiment, extension 16 and probe 14 may each comprise two fibers, one for transmitting light from light source 12 to transducer 18 and one for returning light from transducer 18 to photodetector 30. FIG. 5 shows a probe 14 with two fibers according to this embodiment. In this embodiment, no beam splitter is required, and one fiber of extension 16 (not shown in FIG. 5) connects directly with light source 12 and the other with photodetector 30.

The accuracy, resolution, and repeatability of many fiber-optic sensing systems is dependent largely on the signal to noise ratio of the optical signals transmitted back to photodetector 30. There are many sources of noise, including electronic noise and thermal drift, photodetector shot noise, ambient light noise, thermal noise and others. Judicious selection of components, and design optimization techniques can reduce these effects to acceptable levels in most applications. The largest source of uncertainty in system performance is the quality of the fiber-optic terminations, because the extension cable is designed to be cut and connectorized on site.

Poor terminations reduce the signal amplitude because of scattering losses due to polishing defects and coupling losses due to misalignment and Fresnel reflection losses. Poor terminations can also be a source of noise due to Fabry-Perot interference effects that occur if there is a small gap between fibers at a butt joint. The coupling efficiency is affected by instabilities in the gap spacing on the order of a fraction of a wavelength, which is typically tens of nanometers, so vibrations and thermal instabilities that are present in most industrial environments can result in significant noise levels.

Mating plastic optical fibers to glass optical fibers is further complicated by the inherent mismatch in refractive indices of the two materials. Optical gels can be used to minimize Fresnel reflections, but back-reflections cannot be eliminated by optical gels, nor can the resulting Fabry-Perot interference. Furthermore, optical gels are less reliable for very large core fibers, especially in hostile environments such as elevated temperatures, fumes and vibration, which may cause gels to seep away or develop bubbles.

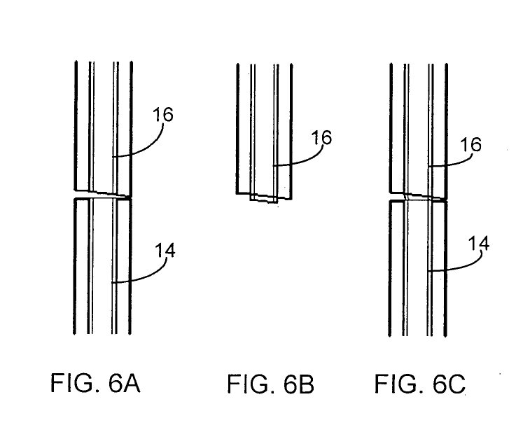

The use of a plastic extension 16 coupled to a glass fiber probe 14 can be made to produce robust and stable coupling, that is tolerant of geometric inaccuracies. FIG. 6A shows a fiber optic junction, exhibiting an angular error caused by a slight tilt in the connector (not shown) during polishing. For glass to glass fiber-optic connections, this would result in a wedged gap between the two fiber faces, which would make the coupling susceptible to Fabry-Perot interference effects. With plastic to glass interfaces, the mating error can be remedied by compressing the plastic fiber against the glass fiber. The plastic fiber 16 is designed to protrude slightly (approximately 0.2 mm) from the cladding, as shown in FIG. 6B, and when the connector, which preferably comprises a compression fitting (not shown) is tightened, the softer plastic material 16 will conform to the face of the glass fiber 14, as shown in FIG. 6C, and compensate for slight misalignments.

Fluorescent fiber optic temperature sensor systems have been described in detail above. However, one skilled in the art will appreciate that the invention is equally applicable to any incoherent fiber optic sensing system, that is, any sensing system which relies only on the intensity of light returning from the sensing probe to make measurements. For example, transducer 18 could comprise a pressure sensor such as a cavity with a pressure sensitive membrane. Transducer 18 could be configured to detect the presence of certain gases in measurement environment 22. Transducer 18 could comprise a coating configured to react to specific chemical substances.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A fiber optic sensing system comprising:
(a) an optical module comprising a light source and a photodetector;
(b) a probe comprising a glass optical fiber core, the probe configured to be coupled to a transducer;
(c) an extension comprising a plastic optical fiber core;
(d) a first connector configured to optically couple the extension to the probe;
(e) a second connector configured to optically couple the extension to the optical module; and,
(f) a signal processor configured to process signals from the photodetector,
wherein light emitted from the light source is transmitted to the probe and returned to the photodetector by the extension.

2. The fiber optic sensing system of claim 1 wherein the light source is incoherent.

3. The fiber optic sensing system of claim 1 wherein the plastic optical fiber core has a diameter greater than 0.25 millimetres.

4. The fiber optic sensing system of claim 1 wherein the plastic optical fiber core is constructed from polymethyl methacrylate.

5. The fiber optic sensing system of claim 1 wherein the glass optical fiber core has a diameter greater than 0.25 millimetres.

6. The fiber optic sensing system of claim 1 wherein the light source emits blue light and the probe is coupled to a transducer comprising a temperature sensitive phosphor configured to emit red light when excited by blue light.

7. The fiber optic sensing system of claim 1 wherein the light source emits broadband light and the probe is coupled to a transducer comprising a cavity with a pressure sensitive membrane.

8. The fiber optic sensing system of claim 1 wherein the probe is coupled to a transducer comprising a coating configured to react to specific chemical substances.

9. The fiber optic sensing system of claim 1 wherein the extension comprises a first plastic optical fiber core and a second optical fiber core, and wherein the second connector is configured to optically couple the first plastic optical fiber core to the light source and the second plastic optical fiber core to the photodetector.
